(19) United States
(12) Patent Application Publication
(10) Pub. No.: US 2026/0312882 A1
(43) Pub. Date: Oct. 8, 2026

(54) Model ID Identification and Configuration for Artificial Intelligence (AI) or Machine Learning (ML)-based Channel State Information (CSI) Compression Models

(71) Applicant: Apple Inc., Cupertino, CA (US)

(72) Inventors: Huaning Niu, San Jose, CA (US); Dawei Zhang, Saratoga, CA (US); Oghenekome Oteri, San Diego, CA (US); Seyed Ali Akbar Fakoorian, San Diego, CA (US); Sigen Ye, San Diego, CA (US); Wei Zeng, Saratoga, CA (US); Weidong Yang, San Diego, CA (US)

(21) Appl. No.: 19/482,602

(22) PCT Filed: Apr. 29, 2024
(86) PCT No.: PCT/US2024/026835

§ 371 Date: Nov. 7, 2025

Related U.S. Application Data
(60) Provisional application No. 63/501,662, filed on May 11, 2023.

(51) Int. Cl. H04L 41/16; H04B 7/06

(52) U.S. Cl. CPC H04L 41/16; H04B 7/0626

(57) ABSTRACT

This application relates to an improved method of operating a user equipment (UE), comprising: transmitting, from the UE, a first capability indication to a base station, wherein the first capability indication relates to capabilities of one or more models for performing at least one task based on artificial intelligence (AI) or machine learning (ML); receiving, at the UE and based on the first capability indication, an indication of a set of model identifiers from the base UE station, wherein model identifiers in the set of model identifiers identify models for performing tasks based on AI or ML; receiving, at the UE, an activation command from the base station, wherein the activation command indicates at least a first model identifier from the set of model identifiers; and activating, by the UE, at least a first model corresponding to the first model identifier for performing a first task based on AI or ML.

### TECHNICAL FIELD

The present application relates to wireless devices and wireless networks, including user devices, terminals, circuits, computer-readable media, and methods for performing model identifier (ID) identification and configuration for Artificial Intelligence (AI) and/or Machine Learning (ML)-based Channel State Information (CSI) compression models.

### BACKGROUND

Wireless communication systems are rapidly growing in usage. In recent years, wireless devices such as smart phones and tablet computers have become increasingly sophisticated. In addition to supporting telephone calls, many mobile devices now provide access to the Internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), Long-Term Evolution (LTE), LTE Advanced (LTE-A), HSPA, 3GPP2 CDMA2000 (e.g., 1xRTT, 1xEV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies and beyond. Accordingly, improvements in the field in support of such development and design are desired.

Increasing interest is developing in the use of artificial intelligence (AI) and machine learning (ML)-based algorithms and tools. It may be possible to utilize such tools in any of a variety of possible areas of wireless communication. Some such areas may include: channel state information (CSI) feedback, beam measurement, and/or direct AI positioning, wherein feedback from a UE or base station (BS) may be used over time to train AI models and/or encoder/decoder pairs (e.g., UE/BS pairs) to improve link budget and/or other wireless communication system characteristics.

It has been agreed in 3GPP RANI that, for AI/ML-based functionality identification, the legacy 3GPP framework of features will be a starting point for discussion. For example, a UE shall be able to indicate supported functionalities for a given use case, and AI/ML-based models may be identified by “model IDs” at the network. Once a UE has indicated its supported AI/ML-based models, the network may perform life cycle management (LCM) of the various models, e.g., by indicating the activation, deactivation, fallback, switching, updating, etc. of particular AI/ML-based functionality (or of particular AI/ML-based models, as identified by their respective model IDs and/or versions) via existing 3GPP signaling (e.g., RRC, MAC-CE, DCI).

However, for LCM performed on the basis that an AI/ML-based model has a model ID with associated information and/or model functionality, there will be at least some AI/ML operations for which the network needs to be aware of the identity and/or status of the UE-side AI/ML model (or of the UE-part of a two-sided model). For example, the model ID may be associated with particular information and/or model functionality, and the network will need to know whether the particular model ID is supported and/or when a new model (or version of a model) should be indicated by a UE to a network.

In the particular case of performing a CSI compression task using a two-sided model, the following AI/ML model training collaboration types have been identified: Type 1: Joint training of the two-sided model at a single side/entity, e.g., UE-sided or network-sided; Type 2: Joint training of the two-sided model at network-side and UE-side, respectively; and Type 3: Separate training at network-side and UE-side, where the UE-side CSI generation part and the network-side CSI reconstruction part are trained by UE-side and network-side, respectively.

Joint training, as used herein, means the generation model (e.g., encoder) and reconstruction model (e.g., decoder) should be trained in the same loop for forward propagation and backward propagation. Joint training could be done both at a single node or across multiple nodes (e.g., through gradient exchange between nodes). The notion of Type 3 “separate training” includes sequential training starting with UE side training, sequential training starting with NW side training, or mixed/parallel training at both the UE and network sides. Other collaboration types are not excluded.

For the particular CSI compression use case, which will be described in greater detail herein, an identifier is needed in the CSI configuration (and reporting) to properly link the encoder at UE side and the decoder at NW side together. If not paired properly, the Precoding Matrix Indicator (PMI), which allows the UE to report its preferred precoding for downlink transmissions on the PDSCH, cannot be correctly reconstructed.

Thus, improvements have been proposed herein to provide techniques for AI-based (and/or Machine Learning (ML)-based) CSI compression, including enhanced mechanisms for model ID identification and configuration—including details regarding model ID design and update procedures—with the goal of allowing simplified model ID identification between UE and network, as well as simpler model ID management.

### SUMMARY

In accordance with one or more embodiments, a method of operating a user equipment (UE) is disclosed herein, the method comprising: transmitting, from the UE, a first capability indication to a base station, wherein the first capability indication relates to capabilities of one or more models for performing at least one task based on artificial intelligence (AI) or machine learning (ML); receiving, at the UE and based on the first capability indication, an indication of a set of model identifiers from the base station, wherein model identifiers in the set of model identifiers identify models for performing tasks based on AI or ML; receiving, at the UE, an activation command from the base station, wherein the activation command indicates at least a first model identifier from the set of model identifiers; and activating, by the UE, at least a first model corresponding to the first model identifier for performing a first task based on AI or ML.

According to some aspects, the first task based on AI or ML comprises at least one of: a Channel State Information (CSI)-related task; a beam management-related task; or a positioning-related task.

According to some aspects, when the first task based on AI or ML comprises a CSI compression task, the first model for performing the CSI compression task comprises a two-sided AI or ML model, wherein a first side of the two-sided AI or ML model is implemented at the UE, and wherein a second side of the two-sided AI or ML model is implemented at the base station. According to some such aspects, an encoder that is implemented at the first side is selected based, at least in part, upon a decoder that is implemented at the second side. According to other such aspects, a decoder that is implemented at the second side is selected based, at least in part, upon an encoder that is implemented at the first side. According to still other such aspects, the first model identifier determines an encoder that is implemented at the first side and a decoder that is implemented at the second side. According to still other such aspects, the first model identifier determines: an encoder that is implemented at the first side and one or more associated decoders that are implemented at the second side; or a decoder that is implemented at the second side and one or more associated encoders that are implemented at the first side. According to still other such aspects, a shared training dataset determines an encoder that is implemented at the first side and a decoder that is implemented at the second side.

In aspects wherein the encoder that is implemented at the first side is selected based, at least in part, upon a decoder that is implemented at the second side, the method may further comprise: receiving, at the UE, an indication of an updated model identifier for an updated version of the first model; determining, at the UE, that the updated model identifier is supported; downloading, at the UE, the updated model identifier and the updated version of the first model; and receiving, at the UE, a second activation command from the base station, wherein the second activation command causes the UE to activate the updated version of the first model.

In aspects wherein the decoder that is implemented at the second side is selected based, at least in part, upon an encoder that is implemented at the first side, the method may further comprise: transmitting, to the base station, an indication of an updated model identifier for an updated version of the first model; receiving, at the UE, a request from the base station to upload the updated version of the first model; transmitting, from the UE, the updated version of the first model to the base station; and receiving, at the UE, a second activation command from the base station, wherein the second activation command causes the UE to activate the updated version of the first model.

In aspects wherein the first model identifier determines an encoder that is implemented at the first side and one or more associated decoders that are implemented at the second side; or a decoder that is implemented at the second side and one or more associated encoders that are implemented at the first side, the method may further comprise: transmitting, to the base station, an indication of an updated version of an encoder of the first model; receiving, at the UE, an updated model identifier from the base station for the updated version of the encoder of the first model; receiving, at the UE, a second model identifier from the base station, wherein the second model identifier indicates a linkage between the updated version of the encoder of the first model and an updated version of a decoder of the first model; and receiving, at the UE, a second activation command from the base station, wherein the second activation command causes the UE to activate the updated version of the encoder of the first model.

In aspects wherein a shared training dataset determines an encoder that is implemented at the first side and a decoder that is implemented at the second side, the method may further comprise: receiving, at the UE, an updated version of the shared training data set; indicating, by the UE to the base station that the updated version of the shared training data set is supported; and receiving, at the UE, a second activation command from the base station, wherein the second activation command causes the UE to activate an updated version of the first model that has been trained using the updated version of the shared training data set.

According to other aspects, the indication of the set of model identifiers are received at the UE via Radio Resource Control (RRC) configuration.

According to still other aspects, receiving the indication of the set of model identifiers from the base station further comprises: receiving a mapping between a globally unique model identifier and a cell-specific model identifier.

According to yet other aspects, the activation command is received via one of: Downlink Control Information (DCI) or Medium Access Control Control Element (MAC CE).

According to some aspects, the method further comprises at least one of the following: deactivating, by the UE, the first model corresponding to the first model identifier; inferencing, by the UE, with the first model corresponding to the first model identifier; or switching, by the UE, to activate at least a second model corresponding to a second model identifier.

According to other aspects, activating at least the first model corresponding to the first model identifier further comprises: activating the first model corresponding to the first model identifier for a first layer or a first rank.

According to still other aspects, activating at least the first model corresponding to the first model identifier further comprises: activating the first model corresponding to the first model identifier for a first layer or a first rank; and activating a second model corresponding to the first model identifier for a second layer or a second rank.

According to yet other aspects, the first model identifier configures one or more of the following parameters: a model structure; a set of models; a quantizer; or a channel state information (CSI) output size.

The various methods and techniques summarized in this section may likewise be performed by a UE device comprising: a receiver; a transmitter; and a processor configured to perform any of the various methods and techniques summarized herein. The various methods and techniques summarized in this section may likewise be stored as instructions in a non-volatile computer-readable medium, wherein the instructions, when executed, cause the performance of the various methods and techniques summarized herein.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates another example of a wireless communication system, according to some aspects.

FIG. 3 illustrates an example block diagram of a UE, according to some aspects.

FIG. 4 illustrates an example block diagram of a Base Station (BS), according to some aspects.

FIGS. 5A-5C illustrate various diagrams detailing methods of performing CSI compression model training, according to some aspects.

FIGS. 6A-6C illustrate various diagrams detailing methods of performing CSI compression model configuration, according to some aspects.

FIGS. 7A-7F illustrate flow diagrams detailing methods of performing model ID identification and configuration for AI-or ML-based CSI compression models, according to some aspects.

FIG. 8 is a flowchart detailing a method of performing model ID identification and configuration for AI-or ML-based CSI compression models, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The present disclosure relates to improved model ID identification and configuration for AI/ML-based Channel State Information (CSI) compression models. In particular, for the AI/ML-based CSI compression use case, an identifier of some kind is needed in the CSI configuration and reporting in order to properly link the encoder portion of the model that is implemented at UE-part and the decoder portion of the model that is implemented at the NW-part together. If not paired properly, the PMI cannot be reconstructed correctly.

Thus, in this disclosure, details will be presented regarding an improved model ID design and update procedure, through the lens of the CSI compression use case. The disclosure will focus, inter alia, on: (1) RRC configuration techniques for layer-common, layer-specific, and/or rank index (RI)-specific AI/ML-based models; (2) ways to design model IDs to identify models to be used for CSI compression; and (3) techniques for updating model IDs over time, e.g., based on model updates and/or the training of new models.

Although the present disclosure uses a CSI compression task as the primary example, it is to be understood that analogous techniques could be applied generally any two-sided AI/ML-based model employed between a UE and a network (and also may be extended to certain one-sided model use cases, as well).

The following is a glossary of additional terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, Play Station Vita™, Play Station Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IOT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

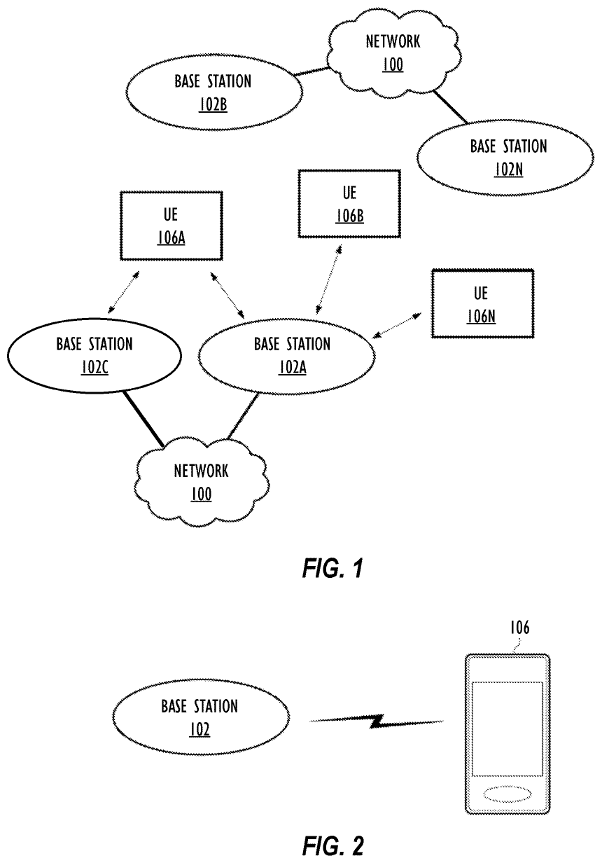

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (VUEs). The RSU may also include internal data storage circuitry to store intersection map geometry, traffic statistics, media, as well as applications/software to sense and control ongoing vehicular and pedestrian traffic. The RSU may operate on the 5.9 GHZ Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

As illustrated in FIG. 2, in one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

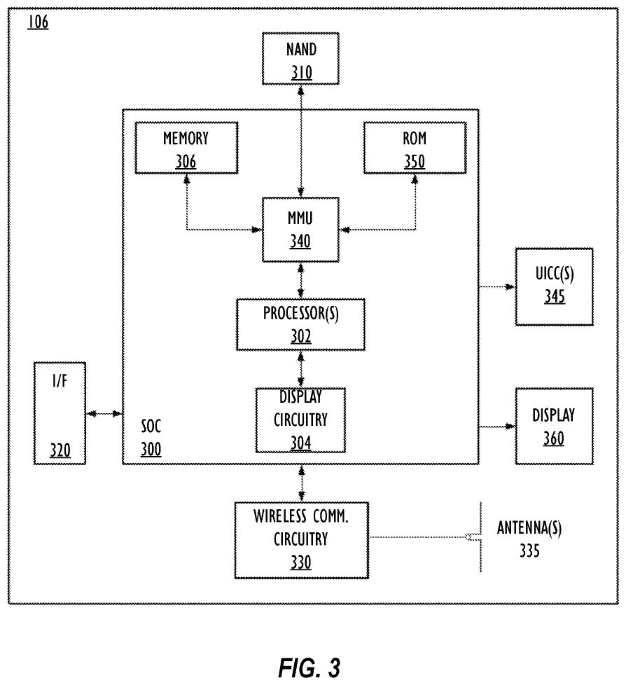

FIG. 3 illustrates an example simplified block diagram of a communication device 106, according to some aspects. It is noted that the block diagram of the communication device of FIG. 3 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components configured to perform core functions. For example, this set of components may be implemented as a system on chip (SOC), which may include portions for various purposes. Alternatively, this set of components may be implemented as separate components or groups of components for the various purposes. The set of components 200 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 (each of which may include an antenna panel), as shown. The wireless communication circuitry 230 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mm Wave frequency range are heavily attenuated by environmental factors. To help address this attenuating, mm Wave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 345 that include Subscriber Identity Module (SIM) functionality, such as one or more Universal Integrated Circuit Card(s) (UICC(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

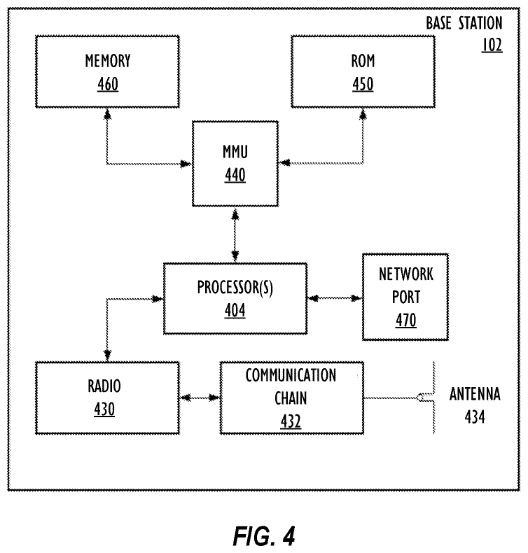

FIG. 4 illustrates an example block diagram of a base station 102, according to some aspects. It is noted that the base station of FIG. 4 is a non-limiting example of a possible base station. As shown, the base station 102 may include processor(s) 304 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas or antenna panels. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mm Wave, the 5G NR radio may be coupled to one or more mm Wave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

### Channel State Information (CSI) Compression Artificial Intelligence (AI)-Based and/or Machine Learning (ML)-Based Model Identification and Configuration

As used herein, Artificial intelligence (AI) refers to the simulation of human intelligence processes by machines, usually computer systems, and Machine learning (ML) refers to a subset of AI that creates algorithms and statistical models to perform a specific task without using explicit instructions, relying instead on patterns and inference. ML algorithms may build mathematical models based on sample data, called training data, to make predictions or decisions without being programmed specifically for that task. Learned signal processing algorithms are expected to empower the next generation of wireless systems with significant reductions in power consumption and improvements in density, throughput, and accuracy when compared to the brittle and manually-designed systems of today.

As mentioned above, CSI compression is an example of a task that may be performed using a two-sided AI/ML model. For example, an encoder portion of the model may be implemented at the UE-part, and a decoder portion of the model may be implemented at the Network-part.

While encoder-decoder pairs may be sufficiently well-specified and efficient given sufficient training samples and associated models, it may also be beneficial to allow independent evolution (e.g., updating) of both the encoder and decoder models over time and as operating environments may change. More specifically, an encoder implemented at a UE may utilize uplink compression techniques when providing information (e.g., training samples) for machine learning models, while a base station may perform decoding or decompression of said training samples, so as to be able to identify or select a compatible machine learning model for communication.

For example, there may be wireless communication scenarios in which a mobile device may need to send a summary of its observations to one or more entities such as a base station (e.g., a gNB), a network side server and/or a UE side server. Moreover, some examples of said observations may include channel state feedback and/or beam measurement feedback, or the like. Furthermore, it may be desirable to minimize the number of bits required to send the observations in order to reduce transmit power, extend battery life, and minimize network and over-the-air uplink resource consumption.

In some embodiments, one approach may be to compress the observations (or associated signaling) to minimize the number of bits required to transmit them. Compression techniques typically require a compressor (e.g., encoder) and matching decompressor (e.g., decoder). According to some scenarios, the encoder should typically be tuned to the statistical characteristics of the observations and acceptable distortion levels. These characteristics may be a function of the device itself (including software version), its operating environment (channel characteristics), the network configuration, among various other factors. In other words, it may be beneficial for an encoder (e.g., a wireless device) to perform occasional or scheduled measurements of its operating environment in order to be aware of the state of the channel in regards to how efficient its wireless communications may be.

Accordingly, when reporting its measurements, it may be further desirable to minimize the number of bits needed to transmit this information. Therefore, before transmission, the encoder may benefit from compressing the measurements or measurement results (e.g., into a reduced number of bits) in order to achieve reduced transmit power (thereby potentially extending battery life) and minimizing uplink resource consumption. Similarly, a decoder in communication with the encoder may also benefit from the reduced number of bits (e.g., compression) of the measurements since decompression of a smaller number of bits may require less processing power.

Further, it may be desirable to allow the network and device software to evolve, update, or change at their own schedules and choose any implementation of encoder and decoder-as long as the two remain compatible. The network may have additional considerations, such as implementing a single decoder that is compatible with the encoders of various device types from different device manufacturers (and/or implementing a single encoder that is compatible with the decoders of various device types from different device manufacturers). Further, both device and network vendors may prefer to accomplish the development of encoders and decoders while preserving user privacy (e.g., identity, location, operating environment) and minimizing the revelation of proprietary information on device or network capabilities and configuration.

According to some embodiments, an encoder-decoder pair may be associated with a model ID. Moreover, the model ID be further be associated or include observation statistics as well as fields of compatibility (e.g., NW vendor identification, UE vendor identification, etc.). Accordingly, the fields corresponding to compatibility may determine whether or not the model ID can be used for communication between the encoder (e.g., compressor) and decoder (e.g., decompressor). Accordingly, it may be beneficial for to develop model identifiers (IDs) for an encoder and decoder using model learning techniques while maintaining compatibility.

For example, by associating a model ID with a collection of observation statistics (e.g., channel characteristics, hardware (HW) or software (SW) versions, network configurations, etc.), when the encoder/decoder pair (e.g., UE/BS pair, as one example) is operating under different conditions (e.g., operating under different channel characteristics, different HW/SW versions, etc.), a different model ID (or model version) may be appropriately selected for more efficient communications corresponding to the pair's current operating conditions, according to some embodiments. Moreover, by updating the observation statistics associated with model IDs, the models can also be effectively updated through the association of the model to the model ID. In other words, updated models used by the encoder/decoder pair would reflect or include updated observation statistics (e.g., channel characteristics, HW/SW versions, etc.) through association of the model ID to the model. Accordingly, more efficient communications between the pair may be realized through continuous or semi-persistent training of the models based on observed conditions and subsequent selection of a compatible and most efficient model ID.

### Multi-Vendor CSI Compression Model Training

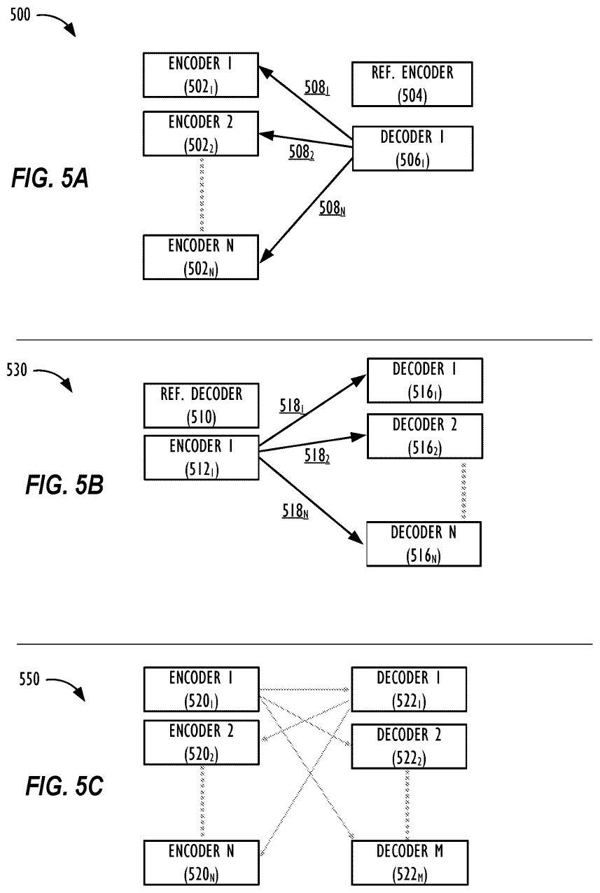

Turning now to FIGS. 5A-5C, various diagrams 500/530/550 detailing methods of performing Channel State Information (CSI) compression model training are illustrated, according to some aspects. In these examples, so called “Type 3” training collaboration may be used, i.e., separate training of the model at the network-side and UE-side, where the UE-side CSI generation part and the network-side CSI reconstruction part are trained by UE-side and network-side, respectively. With Type 3 training collaboration, a model may either be trained at the network-side first or the UE-side first, or a mixed/parallel training approach may be employed.

Referring first to FIG. 5A and diagram 500, a NW-side first Type 3 training example is shown, wherein a single decoder (Decoder 1, 506₁) is initially paired with a reference encoder 504, which may be used to generate a training set for each UE vendor, thereby becoming a supervised learning operation. After the NW-side training, a version of the training dataset 508_{N} may be sent to each of two or more encoders (e.g., Encoder 1, 502₁ through Encoder N, 502_{N}). In this way, a single decoder may be trained with multiple encoders, e.g., encoders from different vendors, manufacturers, or the like.

Referring next to FIG. 5B and diagram 530, a UE-side first Type 3 training example is shown, wherein a single encoder (Encoder 1, 512₁) is initially paired with a reference decoder 510, which may be used to generate a training set for each network vendor. After the UE-side training, a version of the training dataset 518_{N} may be sent to each of two or more decoders (e.g., Decoder 1, 516₁ through Decoder N, 516_{N}). In this way, a single encoder may be trained with multiple decoders, e.g., decoders from different vendors, manufacturers, or the like.

Referring now to FIG. 5C and diagram 550, a mixed/parallel Type 3 training example is shown, wherein a number (N) of encoders (e.g., Encoder 1, 520_{1 v} through Encoder N, 520_{N}) are trained with a number (M) of decoders (e.g., Decoder 1, 522₁ through Decoder M, 522_{M}). In this diagram 550, the UE-side may first perform some training prior to model deployment, and then, after deployment, new UEs may need to be trained to work with existing network decoders.

### CSI Compression Model Configuration

As mentioned above, according to some aspects, CSI compression model configuration may be one or more of: layer-common, layer-specific, and/or rank index (RI)-specific, depending on the needs of a given deployment.

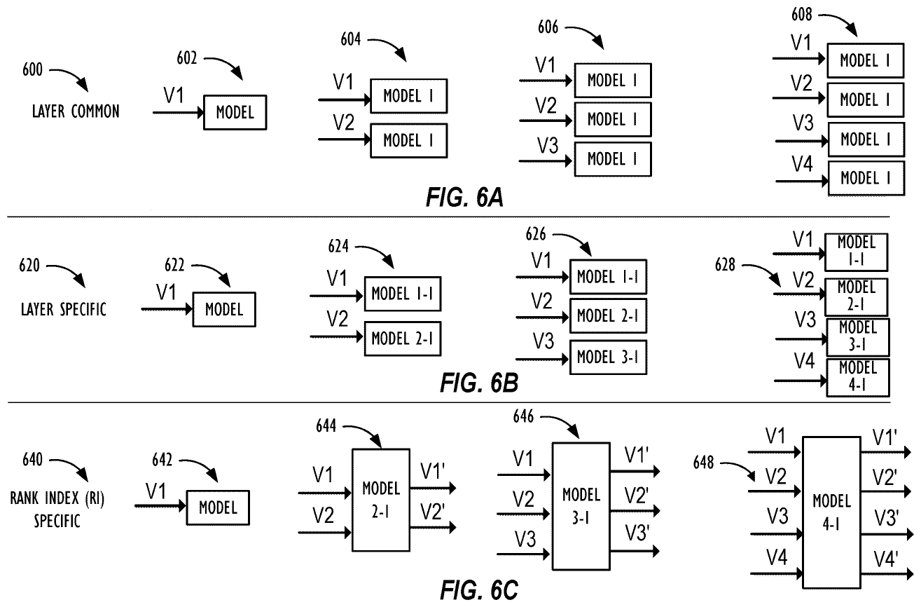

Turning now to FIGS. 6A-6C, various diagrams 600/620/640 detailing methods of performing CSI compression model configuration are illustrated, according to some aspects. Referring first to FIG. 6A and diagram 600, a layer-common model configuration embodiment is illustrated. According to diagram 600, a same model (here, “Model 1”) may be used for each layer that a UE is performing the CSI compression task on. In other words, in single-layer example 602, the single eigenvector V1 goes into the Model 1 encoder, before being quantized and then transmitted over the air to the network-side. According to some aspects, the model index and/or other configuration parameters to be used by the UE may be configured via RRC configuration, as will be described in further detail below.

Moving on to the two-layer example 604, both the first eigenvector V1 and the second eigenvector V2 may use the Model 1-1 encoder, before being quantized and then transmitted over the air to the network-side. In other words, both layers may use the same encoder model. (In this notation format, i.e., Model x-y, the ‘x’ value refers to the layer-or rank-specific value, and the ‘y’ values refers to certain CSI bit value. For example, a model may be designed with a CSI bit value of 50, 100, 200, etc.) Similarly, in the three-layer example 606, each of the three eigenvectors V1, V2, and V3 use the same Model 1-1 encoder for their respective layers, and, in the four-layer example 608, each of the four eigenvectors V1, V2, V3, and V4 use the same Model 1-1 encoder for their respective layers. This layer-common model configuration is simple and may have reduced overhead, but does not allow for further customization of model usage across layers.

Referring next to FIG. 6B and diagram 620, a layer-specific model configuration embodiment is illustrated. According to diagram 620, a different encoder model may be used for each layer that a UE is performing the CSI compression task on. In single-layer example 622, the single eigenvector V1 goes into the Model 1 encoder, before being quantized and then transmitted over the air to the network-side. Moving on to the two-layer example 624, the first eigenvector V1 may use the Model 1-1 encoder, while the second eigenvector V2 may use a different Model 2-1 encoder, before being quantized and then transmitted over the air to the network-side. In other words, both layers may use a layer-specific encoder model. Similarly, in the three-layer example 626, each of the three eigenvectors V1, V2, and V3 may use the Model 1-1, 2-1, and 3-1 encoders, respectively, for their respective layers, and, in the four-layer example 628, each of the four eigenvectors V1, V2, V3, and V4 may use the Model 1-1, 2-1, 3-1, and 4-1 encoders, respectively, for their respective layers. This layer-specific model configuration may have increased overhead, but provides greater customization of model usage across layers.

Referring next to FIG. 6C and diagram 640, a rank index-specific model configuration embodiment is illustrated. According to diagram 640, a different CSI compression encoder models may be used for differently-ranked communications being performed by the UE. In the rank 1 example 642, the single eigenvector V1 goes into the Model 1 encoder, before being quantized and then transmitted over the air to the network-side. In the rank 2 example 644, each of the eigenvectors V1 and V2 uses a different Model 2-1 encoder. Similarly, in the rank 3 example 646, each of the eigenvectors V1, V2, and V3 uses another Model 3-1 encoder, and, in the rank 4 example 648, each of the eigenvectors V1, V2, V3, and V4 uses yet another Model 4-1 encoder. As may now be appreciated, using the example of diagram 640, the choice of which model to use can be determined based on a rank indication received at the UE (e.g., 1-layer MIMO, 2-layer MIMO, 3-layer MIMO, 4-layer MIMO, etc).

### Examples of Model ID Identification and Configuration for CSI Compression Models (or other AI/ML-Based Models)

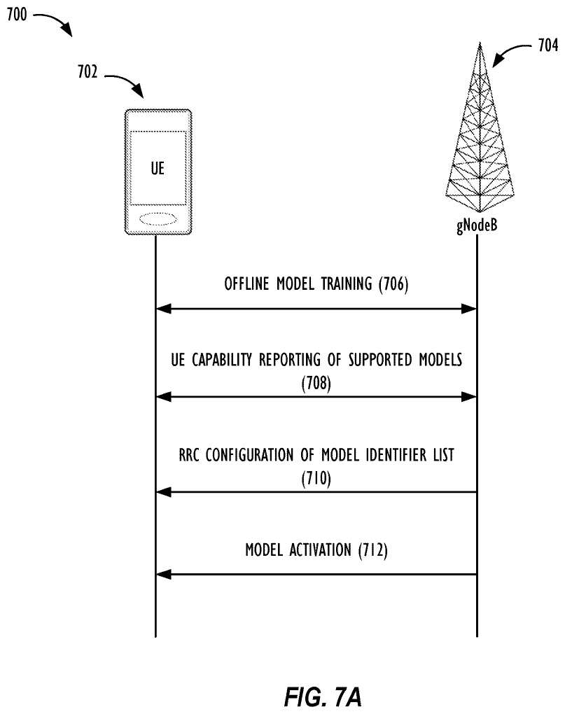

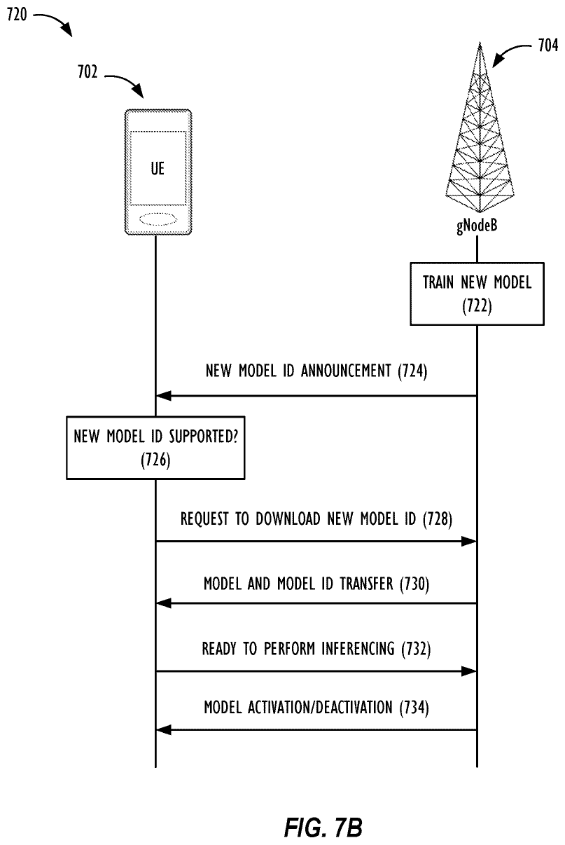

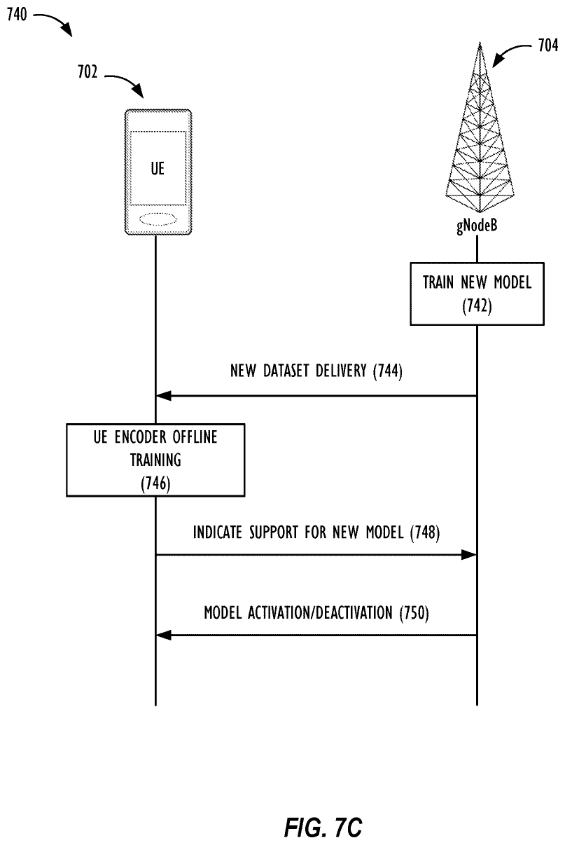

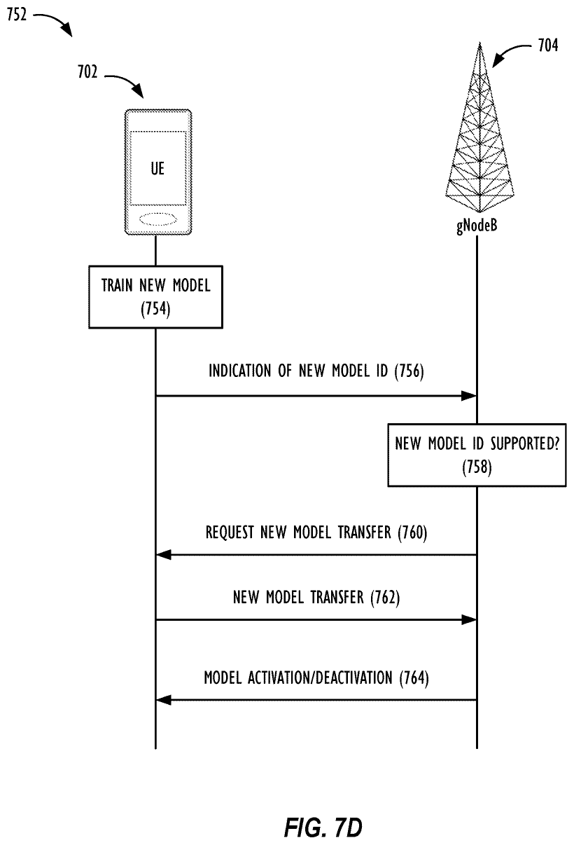

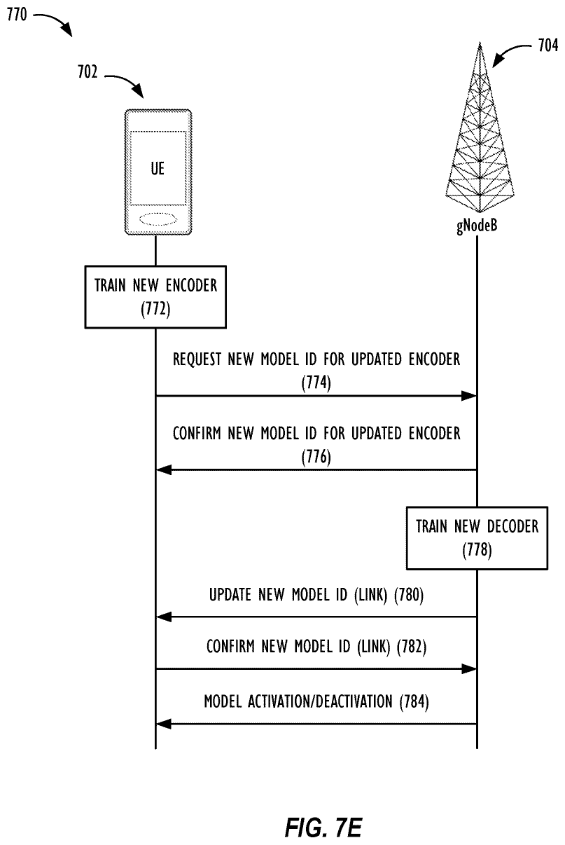

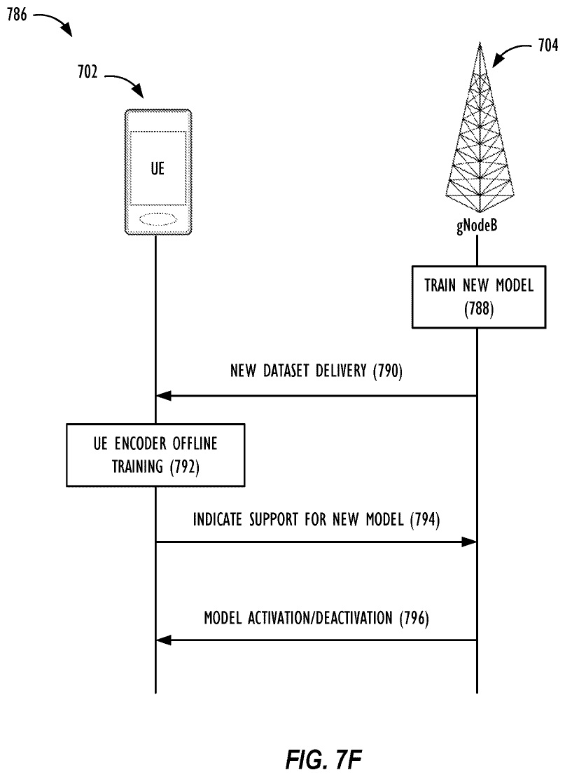

Turning now to FIG. 7A, a flow diagram detailing a method 700 of performing model ID identification and configuration is illustrated, according to some aspects. As introduced above, according to some aspects, before model deployment, offline model training and/or model identification between the UE and network may be performed (e.g., the aforementioned Type 1, Type 2, and Type 3 training collaborations). Thus, method 700 may, thus, begin at 706 by a UE 702 and a network base station, e.g., gNodeB 704, training one or more models offline through a desired training collaboration method.

At 708, the UE 702 and gNB 704 perform an exchange of supported/paired AI/ML-based models, e.g., via UE capability reporting.

At 710, prior to model activation, a set of identifiers may be configured (e.g., via RRC configuration of an identifier or identifier list), which maps globally unique model identifiers to one or more cell-specific model identifiers for the particular UE 702.

Finally, at 712, the gNB 704 may activate/deactivate/switch, etc., the desired AI/ML-based model(s) (or model functionality), e.g., by using the previously RRC-configured ID, as will be explained in greater detail below. The activation/deactivation/switching command from gNB 704 may be transmitted to the UE 702 via MAC CE, DCI, or any other desired signaling method.

According to some aspects, a single RRC-configured ID (e.g., a 3-bit value, such as ‘001’) may be used to configure a single model that is to be used by a UE. In such aspects, for example, using 3-bit values would be able to configure a total of 8 different models to be used by a UE. As described above with reference to FIGS. 6B and 6C, according to some aspects, during inferencing, each layer or each rank can choose different IDs to determine their AI/ML-based model usage.

According to other aspects, a single RRC-configured ID may be used to configure a set of one or more model IDs that are to be used by a UE. For example, for a layer-common or layer-specific configuration, an RRC-configured ID (e.g., the aforementioned exemplary ‘001’ value) may configure different model IDs (or the same model ID) for each of the four layers being used for transmission by a UE. In other words, the per-layer configuration can be the same or different.

Further, if a UE selected to perform rank 2 communications, based on the list of model IDs configured in the RRC configured ID, a layer 1 model ID and a layer 2 model ID may be used to encode the layer 1 and layer 2, respectively. Similarly, for a rank-specific configuration, a particular RRC-configured ID may specify a different model ID (or the same model ID) for each of the ranks that may be used for transmission by a UE.

According to still other aspects, the network can configure one RRC-configured ID or a set of multiple RRC-configured IDs, each of which may itself indicate a model or a list of models to be used by the UE in certain transmission scenarios. According to yet other aspects, a single RRC-configured ID can configure a list of parameters, e.g., a model structure; a set of models; a quantizer; or a CSI output size.

### Model ID Configuration for Two-Sided AI/ML-Based Models

According to some aspects disclosed herein, improved ways of designing model IDs to be able to identify models to be used for CSI compression (or other AI/ML-based tasks) are desired.

According to a first aspect (also referred to herein as “Option 1”), the CSI compression model ID for an encoder that is implemented at the UE-side may selected based, at least in part, upon a decoder that is implemented at the network-side. Option 1 may work well for training collaboration Type 1, where the model is trained at the network-side. As is known, training collaboration Type 1 requires model transfer. Within model transfer, there may be two main distinctions: (1) model transfer in open format of a known model structure to the UE; or (2) model transfer in an open format of an unknown model structure to the UE.

For example, assuming a model ID takes the form of xxx. yyy. zzz (where the x's and y's and z's may represent any alphanumerical identifiers, as desired), if a known model structure is already identified between UE and network through offline agreement, a newly-updated model for the known structure (e.g., a parameter update only) may be marked by one field, such as version ID. For example, a model ID of xxx.yyy.zzz.v1 may represent a version 1 of a model that has been offline identified between UE and (e.g., a parameter update only). In the case of unknown model structures, the model ID will be “new” to the UE the first time that it receives it.

Option 1 may also be well-suited for training collaboration Type 3, with network-side first training. For example, for each network vendor, the network-side may train the reference UE-side CSI generation part (i.e., encoder) and the network-side CSI reconstruction part (i.e., decoder). The network-side may further generate a new training dataset using the reference encoder and forward the dataset to different UE vendors. Each UE vendor may further train its own encoder. For example, one encoder may be trained by a given UE vendor for each network-side dataset (i.e., M encoders for M decoders), or a UE vendor may choose to train a single encoder for all network-side decoders, e.g., by aggregating all the datasets together (i.e., 1 encoder for N decoders). In CSI configuration and UCI feedback, the model ID may be used to indicate which network-side model should be used. The UE may then derive the encoder to be used based on decoder model ID.

According to a second aspect (also referred to herein as “Option 2”), the CSI compression model ID for a decoder that is implemented at the network-side may selected based, at least in part, upon an encoder that is implemented at the UE-side.

Option 2 may work well for training collaboration Type 1, when the model is trained at the UE side. For example, as described above with reference to Option 1, if a known model structure is already identified between UE and network through offline agreement, a newly-updated model for the known structure (e.g., a parameter update only) may be marked by one field, such as version ID. For example, a model ID of xxx.yyy.zzz.v1 may represent a version 1 of a model that has been offline identified between UE and network. In the case of unknown model structures, the model ID will be “new” to the network the first time that it receives it.

Option 2 may also be well-suited for training collaboration Type 3, with UE-side first training. For example, for each UE vendor, the UE-side may train the UE-side CSI generation part (i.e., encoder) and the reference network-side CSI reconstruction part (i.e., decoder). The UE-side further generates training dataset using the encoder and the reference decoder, and then it may forward the dataset to any number of different network vendors. Each network vendor may then further train their own decoder(s). In some cases, a network vendor may only train one decoder for all UE encoders (e.g., by aggregating all datasets). In the case of CSI configuration and UCI feedback, the model ID may be used to indicate which UE side model should be used. The network may then derive the decoder to be used based on encoder model ID.

According to a third aspect (also referred to herein as “Option 3”), the two-sided CSI compression model ID (or other type of two-sided AI/ML-based model) may be identified via both the decoder that is implemented at the network-side and the encoder that is implemented at the UE-side. Option 3 may work well for training collaboration Type 2, when the model is trained at the UE side. In such cases, the model ID may include both UE-side encoder ID and network-side decoder ID (e.g., taking the format of xxx.yyy.encoderID.encoderVersion.decoderID.decoderVersion). After offline training, the UE and network may then know the paired ID through offline agreement.

According to a fourth aspect (also referred to herein as “Option 4”), the two-sided CSI compression model ID (or other type of two-sided AI/ML-based model) may be identified by the link between an encoder that is implemented at the UE-side and one or more associated decoders that are implemented at the network-side (or, conversely, by the link between a decoder that is implemented at the network-side and one or more associated encoders that are implemented at the UE-side). As may be appreciated, the “link” can uniquely link multiple encoders to one decoder, or it can also uniquely link one encoder to multiple decoders. When part of the AI/ML-based model (e.g., either the encoder or the decoder) is updated, the model ID representing the link may then be updated with a new version number.

According to a fifth aspect (also referred to herein as “Option 5”), the two-sided CSI compression model ID (or other type of two-sided AI/ML-based model) may be identified via a shared training dataset ID. Option 5 may work well for training collaboration Type 3, e.g., in situations when one AI/ML-based model may have been trained for multiple datasets and the model is linked to each dataset.

### Model ID Synchronization Procedures for AI/ML-Based Model Updates

According to some aspects disclosed herein, improved techniques for updating model IDs over time, e.g., based on model updates and/or the training of new models, are desired.

Turning now to FIG. 7B, a flow diagram detailing a method 720 of performing model ID identification and configuration (and, in particular, model synchronization that may take place in response to a model update or a newly-trained model) is illustrated, according to some aspects. Method 720 may correspond to the Option 1 scenario described above and may begin at 722 by a network base station, e.g., gNB 704, performing network-side training (e.g., using Type 1 collaboration), to train a new model. According to some aspects, at 724, the network 704 can then indicate, e.g., through RRC signaling, the newly-trained model ID. According to some aspects, this may be achieved using cell-specific signaling or UE-specific signaling. As described above, if the model ID is updated with a new version ID only, this is an indication that the UE already knows about the model's existence and structure. Otherwise, it is an indication that the newly-trained model is unknown to the UE.

At 726, UE 702 may determine whether the new model ID is supported. At 728, the UE may then request to download the model from gNB 704, i.e., based on its capabilities and whether the model is known or unknown. At 730, the new model file, together with the new model ID, may be transmitted to UE 702. At that time, the UE 702 may need to compile the newly-downloaded model (or version) and/or request a UE server to compile the model.

At 732, when UE 702 is ready to run inferencing with the new model, the UE 702 may send an uplink (UL) to the network 704, indicating that the model is ready to be run. According to some implementation, the ready to run message at 732 may be transmitted via UE Assistance Information (UAI), UL MAC CE for a model activation request, or other desired form of UE capability signaling.

Finally, at 734, the gNB 704 may activate/deactivate/switch, etc., the desired AI/ML-based model using the new model ID. As mentioned above, the activation/deactivation/switching command from gNB 704 may be transmitted to the UE 702 via MAC CE, DCI, or any other desired signaling method.

Turning now to FIG. 7C, a flow diagram detailing another method 740 of performing model ID identification and configuration is illustrated, according to some aspects. Method 740 may correspond to the Option 1 scenario described above and may begin at 742 by gNB 704 performing network-side training (e.g., using Type 3 network-first collaboration), to train a new model. With training Type 3, network-first training, the network will first train a new model and then, at 744, the network may transfer the new training dataset to the UE 702 side.

According to some aspects, at 746, the UE-side can perform offline training on the encoder, which may or may not result in the UE making updates to the encoder model. Next, at 748, the UE may indicate to the network that it supports the model and that the model ID should be updated. The supported updated network model ID may be indicating via UE capability report and/or UAI can be used to indicate, e.g., through RRC signaling, the new model ID. Finally, at 750, the gNB 704 may activate/deactivate/switch, etc., the desired AI/ML-based model using the new model ID. As mentioned above, the activation/deactivation/switching command from gNB 704 may be transmitted to the UE 702 via MAC CE, DCI, or any other desired signaling method.

Turning now to FIG. 7D, a flow diagram detailing another method 752 of performing model ID identification and configuration is illustrated, according to some aspects. Method 752 may correspond to the Option 2 or Option 3 scenarios described above. If proceeding according to Option 2, method 752 may begin at 754 by UE 702 performing UE-side training (e.g., using Type 1 UE-sided or Type 3 UE-first collaboration), to train a new model.

At 756, UE 702 may transmit an indication of the newly-trained model ID to the gNB 704. The gNB 704 may, at 758, determine whether the new model ID is supported at the network-side. If it is supported, at 760, the gNB 704 may request a transfer of the new model. In response, at 762, the UE 702 may transfer the newly-trained model to the gNB 704. Finally, at 764, the gNB 704 may activate/deactivate/switch, etc., the desired AI/ML-based model using the new model ID. As mentioned above, the activation/deactivation/switching command from gNB 704 may be transmitted to the UE 702 via MAC CE, DCI, or any other desired signaling method.

If, instead, method 752 proceeds according to Option 3 detailed above, for Type 2 collaboration scenarios (i.e., joint training at the network side and UE-side), the UE may use capability reporting to report the newly available model ID. Alternately, the UE may use UAI to report the updated model ID.

Turning now to FIG. 7E, a flow diagram detailing another method 770 of performing model ID identification and configuration is illustrated, according to some aspects. Method 770 may correspond to the Option 4 scenario described above, wherein a model ID is identified by a link between a UE-side model and a network-side model. Method 770 may begin at 772 by UE 702 performing UE-side training (e.g., using Type 3 UE-first collaboration), to train a new model. At 774, UE 702 may request a new model ID for the updated encoder, and, at 776, the gNB 704 may respond by confirming the request and transmitting the new model ID for the updated encoder to UE 702.

Next, at 778, the gNB 704 may train a new decoder of its own. Once this has been completed, at 780, a new model ID (i.e., a “link” ID) indicating the linkage between the newly-updated encoder and decoder pair may be exchanged between network and UE. At 782, the UE may confirm that the new link ID has been received successfully. Finally, at 784, the gNB 704 may activate/deactivate/switch, etc., the desired AI/ML-based model using the new model ID (i.e., the ID that links the newly-updated encoder and decoder together). As mentioned above, the activation/deactivation/switching command from gNB 704 may be transmitted to the UE 702 via MAC CE, DCI, or any other desired signaling method.

Turning now to FIG. 7F, a flow diagram detailing another method 786 of performing model ID identification and configuration is illustrated, according to some aspects. Method 786 may correspond to the Option 5 scenario described above, wherein a shared training dataset ID is used to identify the two-sides of the CSI compression (or other AI/ML-based) model. Method 786 may begin at 788 by gNB 704 training a new network-side model using a new dataset. Next, at 790 the new dataset may be transmitted to UE 702. At 792, the UE 702 may then train its own new UE-side model using the new dataset, which may or may not result in updates to the encoder. As may be appreciated, in this method 786 example, training collaboration Type 3 is used, with network-first training.

At 794, the UE 702 may indicate to gNB 704 a confirmation of its support for the newly-trained model based on the new dataset. The supported updated model ID may be indicating via UE capability report and/or UAI can be used to indicate, e.g., through RRC signaling, the new model ID. Finally, at 796, the gNB 704 may activate/deactivate/switch, etc., the desired AI/ML-based model using the new model ID (i.e., the ID of the model that has been trained with the new dataset). As mentioned above, the activation/deactivation/switching command from gNB 704 may be transmitted to the UE 702 via MAC CE, DCI, or any other desired signaling method.

### Exemplary Methods

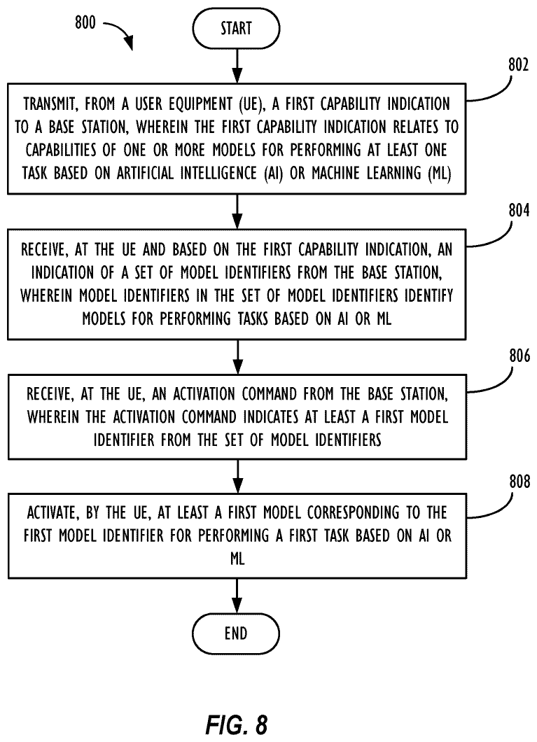

Turning now to FIG. 8, a flowchart 800 detailing a method of performing model ID identification and configuration for AI-or ML-based CSI compression models is illustrated, according to some aspects. First, at block 802, a UE practicing the method of 800 may transmit, from a user equipment (UE), a first capability indication to a base station, wherein the first capability indication relates to capabilities of one or more models for performing at least one task based on artificial intelligence (AI) or machine learning (ML). Next, at block 804, the method 800 may receive, at the UE, and based on the first capability indication, an indication of a set of model identifiers from the base station (e.g., via RRC configuration and the indication of one or more RRC-configured IDs, such as the exemplary 3-bit RRC-configured IDs described above, which may each be used to configure one or more AI/ML-based models to be used for particular layers, ranks, etc.), wherein model identifiers in the set of model identifiers identify models for performing tasks based on AI or ML.

At block 806, the UE may receive an activation command from the base station, wherein the activation command indicates at least a first model identifier from the set of model identifiers. Finally, at block 808 the UE may activate at least a first model corresponding to the first model identifier for performing a first task based on AI or ML.

### Additional Comments

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

1. A method for a user equipment (UE), the method comprising:
transmitting a first capability indication to a base station, wherein the first capability indication relates to capabilities of one or more models for performing at least one task based on artificial intelligence (AI) or machine learning (ML);
receiving, based on the first capability indication, an indication of a set of model identifiers from the base station, wherein model identifiers in the set of model identifiers identify models for performing tasks based on AI or ML;
receiving an activation command from the base station, wherein the activation command indicates at least a first model identifier from the set of model identifiers; and
activating at least a first model corresponding to the first model identifier for performing a first task based on AI or ML.

2. (canceled)

3. (canceled)

4. The method of claim 1, wherein the first model for performing a CSI compression task comprises a two-sided AI or ML model, wherein a first side of the two-sided AI or ML model is implemented at the UE, and wherein a second side of the two-sided AI or ML model is implemented at the base station.

5. (canceled)

6. The method of claim 1, wherein receiving the indication of the set of model identifiers from the base station further comprises:
receiving a mapping between a globally unique model identifier and a cell-specific model identifier.

7. (canceled)

8. The method of claim 1, further comprising at least one of the following:
deactivating, by the UE, the first model corresponding to the first model identifier;
inferencing, by the UE, with the first model corresponding to the first model identifier; or
switching, by the UE, to activate at least a second model corresponding to a second model identifier.

9. (canceled)

10. The method of claim 1, wherein activating at least the first model corresponding to the first model identifier further comprises:
activating the first model corresponding to the first model identifier for a first layer or a first rank; and
activating a second model corresponding to the first model identifier for a second layer or a second rank.

11. The method of claim 1, wherein the first model identifier configures one or more of the following parameters: a model structure; a set of models; a quantizer; or a channel state information (CSI) output size.

12. (canceled)

13. (canceled)

14. The method of claim 4, wherein the first model identifier determines an encoder that is implemented at the first side and a decoder that is implemented at the second side.

15. The method of claim 4, wherein the first model identifier determines:
an encoder that is implemented at the first side and one or more associated decoders that are implemented at the second side; or
a decoder that is implemented at the second side and one or more associated encoders that are implemented at the first side.

16. The method of claim 4, wherein a shared training dataset determines an encoder that is implemented at the first side and a decoder that is implemented at the second side.

17. The method of claim 4, further comprising:
receiving an indication of an updated model identifier for an updated version of the first model;
determining that the updated model identifier is supported;
downloading the updated model identifier and the updated version of the first model; and
receiving a second activation command from the base station,
wherein the second activation command causes the UE to activate the updated version of the first model.

18. The method of claim 4, further comprising:
transmitting, to the base station, an indication of an updated model identifier for an updated version of the first model;
receiving a request from the base station to upload the updated version of the first model;
transmitting the updated version of the first model to the base station; and
receiving a second activation command from the base station,
wherein the second activation command causes the UE to activate the updated version of the first model.

19. The method of claim 15, further comprising:
transmitting, to the base station, an indication of an updated version of an encoder of the first model;
receiving an updated model identifier from the base station for the updated version of the encoder of the first model;
receiving a second model identifier from the base station, wherein the second model identifier indicates a linkage between the updated version of the encoder of the first model and an updated version of a decoder of the first model; and
receiving a second activation command from the base station,
wherein the second activation command causes the UE to activate the updated version of the encoder of the first model.

20-23. (canceled)

24. A wireless device comprising:
a receiver;
a transmitter;
at least one interface; and
a processor configured to cause the wireless device to:
transmit a first capability indication to a base station, wherein the first capability indication relates to capabilities of one or more models for performing at least one task based on artificial intelligence (AI) or machine learning (ML);
receive, based on the first capability indication, an indication of a set of model identifiers from the base station, wherein model identifiers in the set of model identifiers identify models for performing tasks based on AI or ML;
receive an activation command from the base station, wherein the activation command indicates at least a first model identifier from the set of model identifiers; and
activate at least a first model corresponding to the first model identifier for performing a first task based on AI or ML.

25. The wireless device of claim 24, wherein activating at least the first model corresponding to the first model identifier further comprises:
activating the first model corresponding to the first model identifier for a first layer or a first rank; and
activating a second model corresponding to the first model identifier for a second layer or a second rank.

26. The wireless device of claim 24, wherein the first model for performing a CSI compression task comprises a two-sided AI or ML model, wherein a first side of the two-sided AI or ML model is implemented at the UE, and wherein a second side of the two-sided AI or ML model is implemented at the base station.

27. The wireless device of claim 25, wherein the processor is further configured to cause the wireless device to:
receiving an indication of an updated model identifier for an updated version of the first model;
determining that the updated model identifier is supported;
downloading the updated model identifier and the updated version of the first model; and
receiving a second activation command from the base station,
wherein the second activation command causes the UE to activate the updated version of the first model.

28. A baseband processor configured to cause a wireless device to:
transmit a first capability indication to a base station, wherein the first capability indication relates to capabilities of one or more models for performing at least one task based on artificial intelligence (AI) or machine learning (ML);
receive, based on the first capability indication, an indication of a set of model identifiers from the base station, wherein model identifiers in the set of model identifiers identify models for performing tasks based on AI or ML;
receive an activation command from the base station, wherein the activation command indicates at least a first model identifier from the set of model identifiers; and
activate at least a first model corresponding to the first model identifier for performing a first task based on AI or ML.

29. The baseband processor of claim 28, wherein the first model for performing a CSI compression task comprises a two-sided AI or ML model, wherein a first side of the two-sided AI or ML model is implemented at the UE, and wherein a second side of the two-sided AI or ML model is implemented at the base station.

30. The baseband processor of claim 29, wherein the processor is further configured to cause the wireless device to:
receive an indication of an updated model identifier for an updated version of the first model;
determine that the updated model identifier is supported;
download the updated model identifier and the updated version of the first model; and
receive a second activation command from the base station,
wherein the second activation command causes the UE to activate the updated version of the first model.

31. The baseband processor of claim 29, wherein the processor is further configured to cause the wireless device to:
transmit, to the base station, an indication of an updated version of an encoder of the first model;
receive an updated model identifier from the base station for the updated version of the encoder of the first model;
receive a second model identifier from the base station, wherein the second model identifier indicates a linkage between the updated version of the encoder of the first model and an updated version of a decoder of the first model; and
receive a second activation command from the base station,
wherein the second activation command causes the UE to activate the updated version of the encoder of the first model.
